(19) United States
(12) Patent Application Publication
(10) Pub. No.: US 2016/0108865 A1
(43) Pub. Date: Apr. 21, 2016

(54) FUEL VAPOR PROCESSING APPARATUS

(71) Applicant: AISAN KOGYO KABUSHIKI KAISHA, Obu-shi (JP)

(72) Inventors: Naoyuki TAGAWA, Nagoya-shi (JP); Minoru AKITA, Ama-shi (JP); Yoshikazu MIYABE, Obu-shi (JP)

(73) Assignee: AISAN KOGYO KABUSHIKI KAISHA, Obu-shi (JP)

(21) Appl. No.: 14/883,847

(22) Filed: Oct. 15, 2015

(30) Foreign Application Priority Data
Oct. 15, 2014 (JP) 2014-210559

(51) Int. Cl. F02M 25/08; F02D 41/00

(52) U.S. Cl. CPC F02M 25/0809; F02M 25/0836; F02M 25/089; F02D 41/0045

(57) ABSTRACT

A fuel vapor processing apparatus may include a canister, a purge passage connecting the canister and an engine, a vapor passage connecting the canister and a fuel tank, a closing valve disposed in the vapor passage, a pressure detection device for detecting a pressure within the fuel tank, and a controller coupled to the closing valve and the pressure detection device. The controller may output a control signal to the closing valve for opening the closing valve or for closing the closing valve. The controller may include an abnormality determination device that may determine whether or not the pressure detection device is operating properly based a detection value of the pressure detection device detected at a time when the engine is inactive and after the controller outputs the control signal to the closing valve for opening the closing valve or for closing the closing valve.

### CROSS-REFERENCE TO RELATED APPLICATIONS

This application is based upon and claims priority to Japanese Patent Application Serial No. 2014-210559 filed on Oct. 15, 2014, the contents of which are incorporated herein by reference in their entirety for all purposes.

### STATEMENT REGARDING FEDERALLY SPONSORED RESEARCH OR DEVELOPMENT

Not applicable.

### BACKGROUND

This disclosure generally relates to a fuel vapor processing apparatus that may include a canister capable of adsorbing vaporized fuel (i.e., fuel vapor) that may be generated in a fuel tank.

A known fuel vapor processing apparatus is disclosed, for example, in Japanese Laid-Open Patent Publication No. 8-074678. The disclosed fuel vapor processing apparatus includes a canister capable of adsorbing vaporized fuel (i.e., fuel vapor) generated in a fuel tank. The fuel vapor may be adsorbed from the canister so as to be supplied (purged) to an engine. The fuel vapor processing apparatus further includes a closing valve provided in a vapor passage connecting the canister and the fuel tank, and a pressure detection device that can detect the pressure within the fuel tank. The pressure detection device is connected to a first pressure introduction passage communicating with the fuel tank via a switching valve, and also to a second pressure introduction passage for introducing the atmospheric pressure. When the switching valve is switched to the side of the first pressure introduction passage, the pressure detection device can detect the pressure within the fuel tank. When the switching valve is switched to the side of the second pressure introduction passage, the pressure detection device can detect the atmospheric pressure. Thus, with the switching valve switched to the side of the second pressure introduction passage, it may be possible to check whether the detection value of the pressure detection device is equal to the atmospheric pressure or not. Hence, it may be possible to determine whether the pressure detection device is being properly (normally) operating or improperly (abnormally) operating without affecting the driving operation of the engine, etc.

However, in the above-known fuel vapor processing apparatus, the detecting target of the pressure detection device is switched from the fuel tank side to the atmosphere side by the switching valve to determine whether the pressure detection device is being properly operated or being improperly operated. This may lead a complicated structure for determining the abnormality of the pressure detection device.

In view of the above, there is a need in the art for an abnormality determination device for a pressure detection device, which is relatively simple in construction.

### SUMMARY

In one embodiment, a fuel vapor processing apparatus may be used for an engine system. The engine system may include an engine and a fuel tank that stores fuel to be supplied to the engine. The fuel vapor processing apparatus may include a canister for adsorbing fuel vapor produced within the fuel tank, and a purge passage connecting the canister and the engine, so that fuel vapor desorbed from the canister may be purged to the engine via the purge passage. The fuel vapor processing apparatus may further include a vapor passage connecting the canister and the fuel tank, a closing valve disposed in the vapor passage for opening and closing the vapor passage, a pressure detection device coupled to the fuel tank for detecting a pressure within the fuel tank, and a controller coupled to the closing valve and the pressure detection device. The controller may output a control signal to the closing valve for opening the closing valve from a closed position or for closing the closing valve from an open position. In one embodiment, the closing valve may include a valve member actuated by a stepping motor or any other suitable electric actuator that can receive the control signal from the controller. The controller may include a first abnormality determination device that may determine whether or not the pressure detection device is properly operating based a detection value of the pressure detection device detected at a time when the engine is inactive (i.e., stopped) and after the controller outputs the control signal to the closing valve for opening the closing valve or for closing the closing valve.

With this arrangement, it may be possible to determine the abnormality of the pressure detection device without changing a target for detection. In other words, it is not necessary to use a switching device for switching a target for detecting the pressure. Therefore, a complicated determination device may not be necessary. Further, by determining the abnormality when the engine is inactive (i.e., when the engine is at the rest or stopped), the air fuel ratio of the fuel mixture supplied to the engine may not be affected by the determination operation, even in the case that, for example, the fuel vapor stored in the canister has become excessive due to opening of the closing valve.

In one embodiment, the engine system may further include an ignition switch coupled to the engine, so that the engine is activated and deactivated according to turning on and off the ignition switch, respectively. In this case, the controller may be further coupled to the ignition switch and may output the control signal for closing the closing valve when the ignition switch is turned from on to off.

In general, during a purge control for controlling the fuel vapor purged to the engine, the closing valve may be closed in response to turning off the ignition switch, thereby inhibiting communication between the fuel tank and the canister. Therefore, it may not be necessary to specially operate the closing valve for the purpose of determining the abnormality.

The first abnormality determination device may determine that the pressure detection device is operating properly (i.e., normally) if a detection value detected after the controller outputs the control signal to the closing valve for closing the closing valve is equal to or larger than a predetermined value that may be a value near a minimum detection value of the pressure detection device.

In one embodiment, the engine system may further include a lid for opening and closing a refueling port of the fuel tank. In this case, the controller may be further configured to output the control signal to the closing valve to open the closing valve from the closed position when the lid is open.

In general, during the purge control, the closing valve may be opened in response to the opening of the lid of the refueling port for introducing the fuel vapor produced within the fuel tank to the canister via the vapor passage. Therefore, it may not be necessary to specially operate the closing valve for the purpose of determining the abnormality.

The first abnormality determination device may be further configured to suspend the determination of the abnormality if a detection value detected at a time when or before the controller outputs the control signal to the closing valve for opening the closing valve from the closed position and before a predetermined time elapses after turning off the ignition switch is smaller than a predetermined value that may be a value near the minimum detection value of the pressure detection device.

With this arrangement, it may be possible to avoid such an occasion that the pressure detection device is wrongly determined to be abnormal when the pressure within the fuel tank has not increased to the predetermined value due to shortage of time.

The first abnormality determination device may be further configured to determine that the closing valve properly operates if a detection value detected after the controller outputs the control signal to the closing valve for opening the closing valve is smaller than a predetermined value that may be a value near a maximum detection value of the pressure detection device.

In one embodiment, the controller may further include a second abnormality detection device configured to determine whether the closing valve is in an abnormal condition (i.e., when the closing valve is operating improperly) or a normal condition (i.e., when the closing valve is operating properly). The abnormal condition may be a condition in which the closing valve is accidentally fixed in an open position. The second abnormality detection device may determine that the closing valve is in the normal condition if a detection value detected after the controller outputs the control signal to the closing valve for closing the closing valve is larger by a predetermined value than a detection value detected by the pressure detection device at a time when the ignition switch is turned from on to off.

Thus, it may be determined that the closing valve properly (i.e., normally) operates for closing if the detection value detected after closing the closing valve is larger by the predetermined value than the detection value detected when the ignition switch is turned on. In this way, the determination of the abnormality of the closing valve can be performed simultaneously with or sequentially to the determination of the abnormality of the pressure detection device.

In another or alternative embodiment, the controller may further include a second abnormality detection device configured to determine whether the closing valve is in an abnormal condition (i.e., when the closing valve is operating improperly) or a normal condition (i.e., when the closing valve is operating properly). In this embodiment, the abnormal condition may be a condition in which the closing valve is accidentally fixed in a closed position. The second abnormality detection device may determine that the closing valve is in the normal condition if a detection value detected after the controller outputs the control signal to the closing valve for opening the closing valve is smaller by a predetermined value than a detection value detected at a time when the lid is opened from a closed position.

Thus, it may be determined that the closing valve properly (i.e., normally) operates for opening if the detection value detected after opening the closing valve is smaller by the predetermined value than the detection value detected when the lid is opened to open the refueling port. In this way, the determination of the abnormality of the closing valve can be performed simultaneously with or sequentially to the determination of the abnormality of the pressure detection device.

### BRIEF DESCRIPTION OF THE DRAWINGS

FIG. 1 is a schematic view illustrating a vehicle engine system incorporating a fuel vapor processing apparatus according to a representative embodiment;

FIG. 2 is a flowchart illustrating a 0V sticking determination process (an abnormality determination process with respect to “0V sticking”) of a pressure detection device and an abnormality determination process with respect to fixation at an open position of a closing valve of the fuel vapor processing apparatus;

FIG. 3 is a flowchart illustrating a detail of an abnormality determination process I with respect to “0V sticking” shown in FIG. 2;

FIG. 4 is a flowchart illustrating a detail of an abnormality determination process II with respect to “0V sticking” shown in FIG. 2;

FIG. 5 illustrates time charts showing the relationship between operations for turning on and off of an ignition switch, operations for turning on and off of a lid switch, a change in pressure within a fuel tank (the detected value of the tank internal pressure), and operations for closing and opening the closing valve of the fuel vapor processing apparatus;

FIG. 6 is a flowchart illustrating a 5V sticking determination process (an abnormality determination process with respect to “5V sticking”) of the pressure detection device and an abnormality determination process with respect fixation at a closed position of the closing valve of the fuel vapor processing apparatus;

FIG. 7 is a flowchart illustrating a detail of the 5V sticking determination process shown in FIG. 6; and

FIG. 8 illustrates time charts showing the relationship between the operations for turning on and off the ignition switch, the operations for turning on and off the lid switch, the change in pressure within the fuel tank (the detected value of the tank internal pressure), and the operations for closing and opening the closing valve.

### DETAILED DESCRIPTION

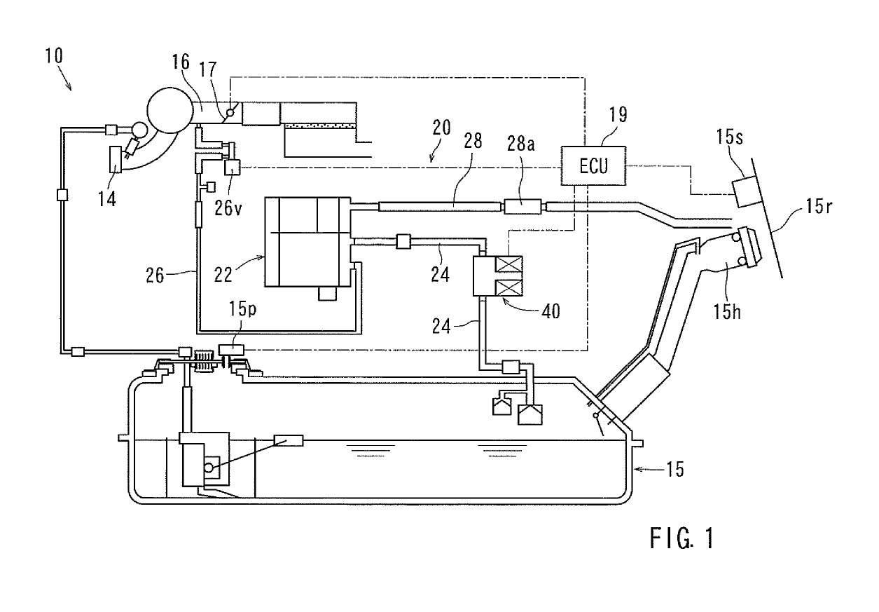

A fuel vapor processing apparatus 20 according to a representative embodiment will now be described with reference to FIGS. 1 through 8. As shown in FIG. 1, the fuel vapor processing apparatus 20 may be used for a vehicle engine system 10. The fuel vapor processing apparatus 20 may inhibit fuel vapor that may be produced within a fuel tank 15 of the vehicle, from leaking to the outside of the vehicle engine system 10.

As shown in FIG. 1, the fuel vapor processing apparatus 20 may generally include a canister 22, a vapor passage 24 connected to the canister 22, a purge passage 26, and an atmospheric passage 28. The canister 22 may contain activated carbon (not shown) as an adsorbent that can adsorb fuel vapor produced within the fuel tank 15. One end (upstream end) of the vapor passage 24 may be in fluid communication with an upper gaseous space formed in the fuel tank 15. The other end (downstream end) of the vapor passage 24 may be in fluid communication with the interior of the canister 22. At a point along the vapor passage 24, a closing valve 40 may be disposed. The closing valve 40 may open and close the vapor passage 24 to permit communication between the upstream side and the downstream side of the closing valve 40 and to prevent (i.e., shut-off) communication between the upstream side and the downstream side of the closing valve 40. In one embodiment, the closing valve 40 may include a valve member (not shown in the drawings) and a stepping motor (not shown in the drawings) coupled to the valve member and serving as an actuator of the valve member. The stepping motor may be coupled to (in electrical communication with) an engine control unit 19 (hereinafter referred to as “ECU 19”) that may output a control signal to the stepping motor. Based on the control signal, the stepping motor may be driven to move the valve member in closing valve 40 for opening and closing the valve member.

One end (upstream end) of the purge passage 26 may be in fluid communication with the interior of the canister 22, and the other end (downstream end) of the purge passage 26 may be in fluid communication with an intake passage 16 of the engine 14 at a position on the downstream side of a throttle valve 17 disposed in the intake passage 16. At a point along the purge passage 26, a purge valve 26v may be disposed. The purge valve 26v may open and close the purge passage 26 to permit communication between the upstream side and the downstream side of the purge valve 26v and to prevent (i.e., shut-off) communication between the upstream side and the downstream side of the purge valve 26v. In one embodiment, the purge valve 40 may be an electrically operated valve, such as an electromagnetic valve, that is coupled to (in electrical communication with) the ECU 19. The ECU 19 may output a control signal to the purge valve 26v, so that the purge valve 26v is opened and closed based on the control signal. An air filter 28a may be disposed in the atmospheric passage 28 at a point along the atmospheric passage 28. One end of the atmospheric passage 28 may be in fluid communication with the canister 22, and the other end of the atmospheric passage 28 may be open to the atmosphere at a position in the vicinity of a refueling port 15h of the fuel tank 15.

In one embodiment, the refueling port 15h may be positioned in the vicinity of and on the inner side of a surface panel of a vehicle body (not shown). The refueling port 15h may be closed by a lid 15r that can be opened and closed. The lid 15r may include a lid switch 15s that can detect opening and closing of the lid 15r. The detection signal of the lid switch 15s may be input to the ECU 19. More specifically, when the lid switch 15s outputs an on signal, the ECU 19 determines that the lid 15r is open. In this state, it may be possible to refuel the fuel tank 15. In other words, the on signal may indicate that the refueling port 15h is open. Further, the ECU 19 may receive is a detection signal of a tank internal pressure sensor 15p that can detect the pressure within the fuel tank 15 (hereinafter called a “tank internal pressure”). More specifically, the tank internal pressure sensor 15p may output a detection signal that may be a voltage signal having a voltage value within a range of 0 V and 5 V, that represents the pressure within the fuel tank 15. In other words, the tank internal pressure sensor 15p may convert the pressure value into an electric signal representing the voltage value. The detection signal may be output to the ECU 19. In this embodiment, “0 V” may be a minimum detection value. For example, “0 V” may correspond to the atmospheric pressure. “5 V” may be a maximum detection value. For example, “5 V” may correspond to a pressure value of the tank internal pressure that may be achieved when a predetermined period D (that will be explained later) has elapsed after closing the closing valve 40 while the tank internal pressure sensor 15p and the closing valve 40 are operating properly. The pressure value corresponding to “5 V” may be appropriately determined, for example, by experimentation. The voltage value of the voltage signal may proportionally increase as the tank internal pressure increases. In this way, the tank internal pressure sensor 15p may serve as a pressure detection device for detecting the pressure within the fuel tank 15.

After an ignition switch (hereinafter also referred to as an “IG”) has been turned on to activate the engine 14, the ECU 19 may perform a purge control in which the fuel vapor adsorbed by the adsorption material of the canister 22 may be desorbed and purged to the engine 14. During the purge control, the purge valve 26v may be controlled so as to be opened and closed while the canister 22 is in fluid communication with the atmosphere via the atmospheric passage 28. When the purge valve 26v is opened, a negative pressure that may be produced in the intake passage 24 of the engine 14 may be applied to the interior of the canister 22 via the purge passage 16. As a result, the atmospheric air may flow into the canister 22 via the atmospheric passage 28. Further, when the purge valve 26v is opened, the closing valve 40 may be opened to perform a pressure releasing control of the fuel tank 15. As a result, a mixture of air and fuel vapor (hereinafter called a “fuel vapor containing gas”) contained in the fuel tank 15 may flow into the canister 22 via the vapor passage 24. Hence, the atmospheric air flowing into the canister 22 may desorb the fuel vapor from the adsorption material contained in the canister 22, and the desorbed fuel vapor may be purged to the engine 14 via the intake passage 16 along with the air for burning in the engine 14.

When the ignition switch is turned off to inactivate the engine 14, the ECU 19 may close the purge valve 26v to shut off the purge passage 26. At the same time, the ECU 19 may close the closing valve 40 from the open position, to shut off the vapor passage 24. Therefore, the fuel tank 15 may be substantially hermetically closed, so that the fuel vapor can be retained in the fuel tank 15 without flowing into the canister 22. This may cause an increase in the pressure within the fuel tank 15 (i.e., the tank internal pressure). However, when refueling the fuel tank 15, that is, when the lid 15r is opened, the lid switch 15s may be turned on. Based on the signal from the lid switch 15s, the ECU 19 may open the closing valve 40 from the closed position for opening the vapor passage 24. Therefore, the fuel vapor produced within the fuel tank 15 may be introduced into the canister 22 via the vapor passage 24 so as to be adsorbed by the adsorption material. As a result, the tank internal pressure may decrease.

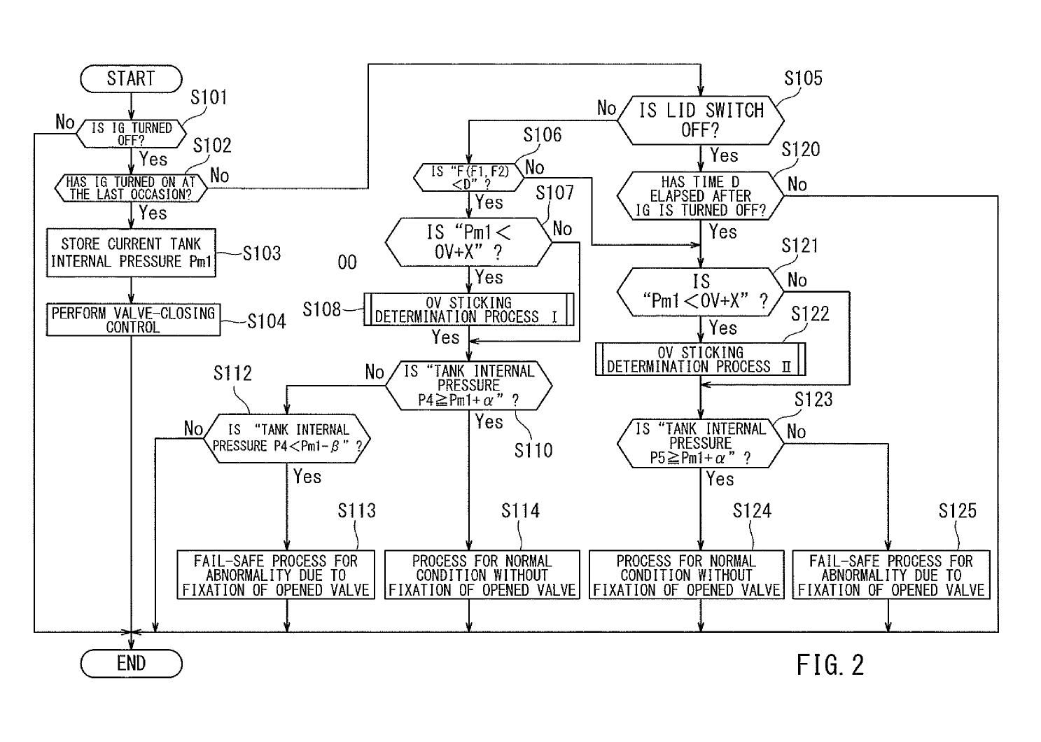

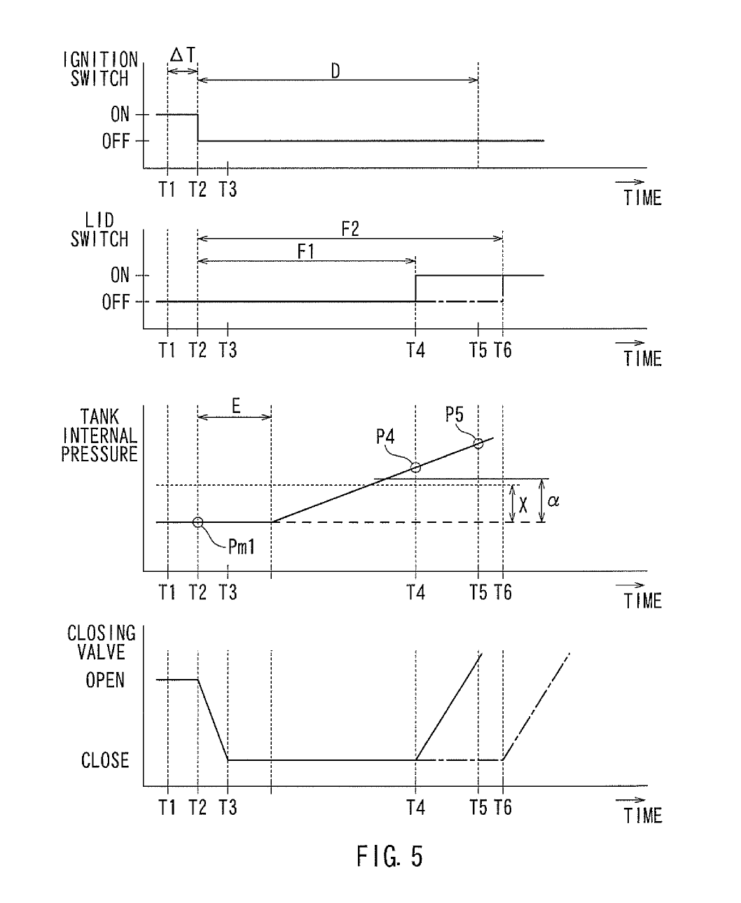

A process for determining abnormality of the tank internal pressure sensor 15p, and a process for determining abnormality of the closing valve 40 according to a first mode will now be described with reference to the flowcharts shown in FIGS. 2 through 4 and the time charts shown in FIG. 5. The processes shown in the flowcharts of FIGS. 2 through 4 may be cyclically or periodically performed with a period of a predetermined time (ΔT) according to a control program stored in the memory of the ECU 19. FIG. 5 illustrates the relationship between the operations for turning on and off the ignition switch (IG), the operations for turning on and off the lid switch 15s, a change in the tank internal pressure, and the operations for opening and closing the closing valve 40 during the process for determining the abnormality of the tank internal pressure sensor 15p, and during the process for determining the abnormality of the closing valve 40, with time indicated by the horizontal axis. As will be described later, the processes according to the first mode may use the value “0 V+X” as a reference for comparison with the detected pressure value for determining the abnormality that may be caused by sticking of the tank internal pressure sensor 15p. Therefore, the process for determining the abnormality of the tank internal pressure 15p according to the first mode will be also referred to as a “0 V sticking determination process.” Here, the term “sticking of the tank internal pressure sensor 15p” is used to mean that a movable member, such as a diaphragm of the tank internal pressure sensor 15p, that moves in response to the detected pressure is accidentally stuck to the another element, such as a wall of a sensor body supporting the movable member.

The processes illustrated in the flowcharts of FIGS. 2 through 4 will be described in chronological order. First, at time T1 in FIG. 5, the ignition switch was already turned on (i.e., the ignition switch is being turned on at time T1), so that the engine 14 is being activated or driven. In addition, at time T1, the lid switch 15s is turned off, so that the lid 15r is closed. Further, at time T1, the closing valve 40 is open, so that the canister 22 and the fuel tank 15 are in fluid communication with each other via the vapor passage 24. Therefore, determination in Step S101 (“IS IG TURNED OFF?”) off?” in the process shown in FIG. 2 is “No”, and the process may be completed. At time T2 in FIG. 5, the ignition switch IG is switched from on to off, so that the determination in Step S101 of FIG. 2 is “Yes.” Then, the process may proceed to Step S102 that determines as to whether or not the ignition switch (IG) was turned on at the last occasion (i.e., during performing the process at the last cyclic period). In FIG. 5, at the last occasion (at time T1), the ignition switch was tuned on (and therefore the determination in Step S102 is “Yes”). Then, the ECU 19 may store the current tank internal pressure Pm1 at Step S103. The tank internal pressure Pm1 may be detected by the tank internal pressure sensor 15p. In this embodiment, the tank internal pressure Pm1 may output a voltage signal of between 0 V and 5 V as the detection signal as described previously. Subsequently, the stepping motor of the closing valve 40 that is in the open state may be driven in a closing direction for closing the closing valve 40 at Step S104. Then, the process may be completed. Here, as described previously, when the closing valve 40 is closed to shut off the vapor passage 24, the fuel tank 15 may be substantially hermetically closed. Therefore, the tank internal pressure may gradually increase due to increase of the fuel vapor produced within the fuel tank 15 after that.

Next, at Time T3 in FIG. 5, the ignition switch is turned off, and the ignition switch was turned off at the last occasion (i.e. at time T2). Therefore, the determination at Step 101 is “Yes”, and the determination in Step S102 is “No.” The process may then proceed to Step S105 that determines whether or not the lid switch 15s is turned off. At time T3, the lid switch 15s is turned off (“Yes” in Step S105), so that the process may proceed to Step S120 to determine whether or not the period of time D has elapsed after time T2 (i.e., after the ignition switch has been tuned from on to off). The period of time D may be set to be sufficiently larger than time E (see a graph portion of FIG. 5 showing a change of the tank internal pressure) during which the pressure within the fuel tank 15 may increase through the closing of the closing valve 40 but the tank internal pressure sensor 15p may not be possible to detect such an increase in the tank internal pressure, for example, due to delay in response. At time T3, the period of time D has not elapsed after the ignition switch has been turned off. Therefore, the determination in Step S120 is “No”, and the process may then be completed.

In this way, with passage of time, Steps S101, S102, S105, and 120 in FIG. 2 may be repeatedly performed until the lid switch 15s is turned on at Time T4 of FIG. 5 due to opening of the lid 15r (i.e., until the determination in Step 105 becomes “No”). When the lid 15r is opened to enable refueling (i.e., when the fuel supply port 15h is opened), the closing valve 40 may open the vapor passage 24 as described previously (see the lower part of FIG. 5). Then, the process may proceed to Step S106 that determines whether or not a period of time F1 is shorter than the period of time D. The period of time F1 may be a period until the lid switch 15s is tuned on after the ignition switch has been turned from on to off. At time T4, the period of Time F1 is shorter than the period of Time D (such that the determination in Step S106 is “Yes”). Therefore, the process may proceed to Step S107 that determines whether or not the tank internal pressure Pm1 (0 V to 5 V) stored at time T2 (i.e., the time when the ignition switch is turned off) is smaller than “0 V+X” (i.e., Pm1<0 V+X). In one embodiment, X may be set to approximately 0.3 V. Should the tank internal pressure Pm1 be larger than “0 V+X” (such that the determination in Step S107 is “No”), it may be considered that the tank internal pressure sensor 15p is not in an abnormal state (0 V sticking state) but is in a normal state. In other words, it may be considered that the tank internal pressure sensor 15p is properly operating. Then, the process may proceed to Step S110 without performing a 0 V sticking determination process I that will be described later. Should the tank internal pressure Pm1 be smaller than “0 V+X” (such that the determination in Step S107 is “Yes”), the process may proceed to Step S108 in which the 0 V sticking determination process I is performed.

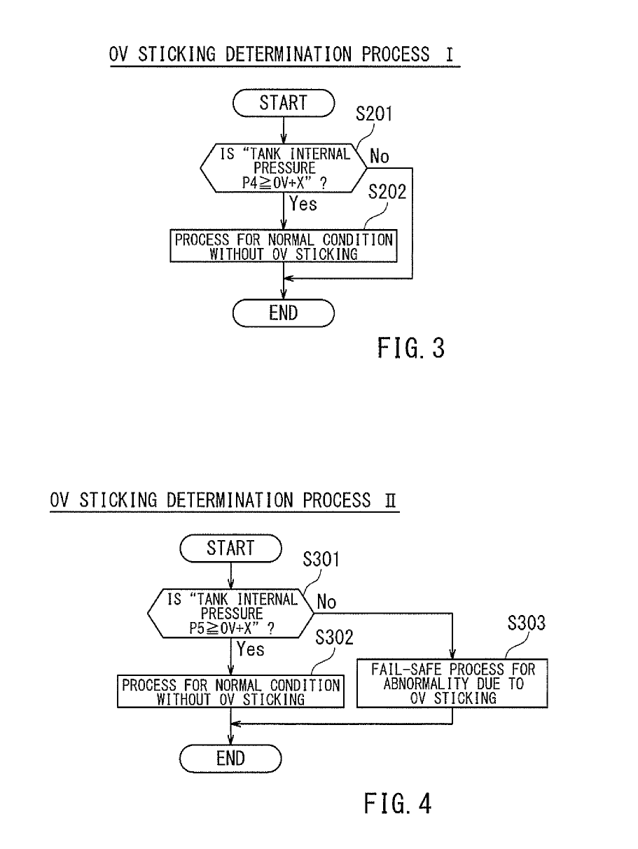

The 0 V sticking determination processing I may be performed according to the flowchart shown in FIG. 3. First, Step S201 may compare the tank internal pressure P4 detected at time T4 with “0 V+X.” Should the tank internal pressure P4 be larger than “0 V+X” as shown in the time chart for the tank internal pressure or equal to “0 V+X” (i.e., P4≧0 V+X), determination at Step 201 is “Yes.” In this case, it may be considered that the tank internal pressure sensor 15p is not in the abnormal state (i.e., the 0 V sticking state) but is instead in the normal state. Then, the process may proceed to Step S202 in which a process for the normal condition without 0 V sticking may be performed. For example, this process may output a signal indicating that no abnormality has occurred. After that, the process may proceed to Step S110 in the flowchart of FIG. 2. Should the tank internal pressure P4 be smaller than “0 V+X” (“No” in Step S201 of FIG. 3), the determination with respect to the abnormality of the tank internal pressure sensor 15p may be suspended because the tank internal pressure P4 may possibly increase with passage of the period of time D. Then, the process may proceed to Step S110 of FIG. 2. As described previously, in this embodiment, the detection value of 0 V of the tank internal pressure sensor 15p (tank internal pressure) may be a minimum detection value, and “0 V+X” may be a predetermined value that is larger than and near the minimum detection value.

Step S110 in FIG. 2 may compare the tank internal pressure P4 with the tank internal pressure Pm1 stored at time T2 (when the ignition switch was turned off). Should the tank internal pressure P4 at Time T4 be larger than “Pm1+α” as shown in the time chart for the tank internal pressure or equal to “Pm1+α” (i.e., P4≧Pm1+α), the determination at Step 110 is “Yes.” In this case, it may be considered that the tank internal pressure has increased by a value of a or more through the closing of the closing valve 40 from the open state (i.e., fully opened position) at the time when the ignition switch was turned off. This may mean that the closing valve 40 has properly (i.e., normally) operated for closing and has not been fixed in the open position. Therefore, the process may proceed to Step S114, in which a process for a normal condition without fixation of the closing valve 40 at the open position may be performed. For example, this process may output a signal indicating that no abnormality has occurred. Should the tank internal pressure P4 be smaller than “Pm1+α” (such that the determination in Step S110 is “No”), and larger than “Pm1−β” (such that the determination in Step S112 is “No”), the determination of the closing valve 40 with respect the fixation at the open position may be suspended because there is a possibility that the tank internal pressure P4 will increase further with passage of time. The process may be then finished. Should the tank internal pressure P4 be smaller than “Pm1+α” (such that the determination in Step S110 is “No”), and smaller than “Pm1−β” (such that the determination in Step S112 is “Yes”), there is a possibility that the closing valve 40 has been fixed in the open position. Therefore, the process may proceed to Step S113, in which a fail-safe process for abnormality due to the fixation of the closing valve 40 at the open position may be performed. For example, the fail-safe process may output a signal indicating that an abnormality has occurred.

If the lid switch 15s is not turned on at time T4 but is turned on at time T6 in FIG. 5 (see chain lines in FIG. 5), the lid switch 15s is being turned off at time T5 of FIG. 5 (“Yes” in Step S105 of FIG. 2). Therefore, the process may proceed to Step S120 that determines whether or not the period of time D has elapsed after time T2 (when the ignition switch was turned off). At time T5, the period of time D has elapsed (such that the determination in Step S120 is “Yes”), so that the process may proceed to Step S121 that determines whether or not the tank internal pressure Pm1 (0 V to 5 V) stored at time T2 (when the ignition switch was turned off) is smaller than “0 V+X”. Should the tank internal pressure Pm1 be larger than “0 V+X” (such that the determination in Step S121 is “No”), it may be considered that the tank internal pressure sensor 15p is not in the 0 V sticking state but is instead in the normal state. Therefore, the process may then proceed to Step S123 without performing a 0 V sticking determination process II that will be described later. Should the tank internal pressure Pm1 be smaller than “0 V+X” (such that the determination in Step S121 is “Yes”), the 0 V sticking determination processing II may be performed at Step S122.

The 0 V sticking determination process II may be performed according to the flowchart shown in FIG. 4. Step S301 may compare the tank internal pressure P5 detected at time T5 with “0 V+X”. Should the tank internal pressure P5 at time T5 be larger than “0 V+X” as shown in the time chart for the tank internal pressure or equal to “0 V+X” (i.e., P5≧0 V+X), it may be considered that the tank internal pressure sensor 15p is not in the 0 V sticking state (i.e., an abnormal state) but in the normal state. Therefore, the process may proceed to Step S302 that performs a process for a normal condition without 0 V sticking. For example, this process may output a signal indicating that no abnormality has occurred. The process may then proceed to Step S123 in FIG. 2. Should the tank internal pressure P5 be smaller than “0 V+X” (“No” in Step S301 of FIG. 4), it may be considered that the tank internal pressure has not increased sufficiently even when the period of time D has elapsed. This may mean that there is a possibility that the tank internal pressure sensor 15p is in the 0 V sticking state (i.e., the abnormal state). Therefore, the process may proceed to Step S303 in which a fail-safe process for abnormality due to the 0V sticking may be performed. For example, the fail-safe process may output a signal indicating that an abnormality has occurred. Based on this signal, an appropriate process may be performed to prevent the tank internal pressure from being excessively increased. In one embodiment, based on this signal, the ECU 19 may control the closing valve 40 to be opened when the tank internal pressure has increased to exceed a predetermined value, so that the tank internal pressure may be released to the canister 22. Thereafter, the process may proceed to Step S123 of FIG. 2.

Step S123 of FIG. 2 may compare the tank internal pressure P5 detected at time T5 with the tank internal pressure Pm1 previously stored at time T2 (when the ignition switch was turned off). Should the tank internal pressure P5 at time T5 be larger than “Pm1+α” as shown in the time chart for the tank internal pressure or equal to “Pm1+α” (i.e., P5≧Pm1+α), it may be considered that the tank internal pressure has increased by a value of a or more through the closing of the closing valve 40 from the open state at the ignition-off time. This may mean that the closing valve 40 has properly (i.e., normally) operated for closing and has not been fixed in the open position. Therefore, the process may proceed to Step S124, in which a process for a normal condition without fixation of the closing valve 40 at the open position is performed. For example, this process may output a signal indicating that no abnormality has occurred. Should the tank internal pressure P5 be smaller than “Pm1+α” (“No” in Step S123), this may mean that the tank internal pressure P5 has not increased sufficiently even though the period of Time D has elapsed. Therefore, there is a possibility that the closing valve 40 has been fixed in the open position. Then, the process may proceed to Step S125, in which a fail-safe process for abnormality due to the fixation of the closing valve 40 at the open position is performed. For example, the fail-safe process may output a signal indicating that an abnormality has occurred.

Should the lid switch 15s be turned on at time T6 of FIG. 5, determination at Step S105 in FIG. 2 is “No” at time T6. Therefore, the process may proceed to Step S106 that compares a period of time F2 with the period of time D. The period of Time F2 may be a period after the ignition switch is turned off until the lid switch 15s is turned on. Should the period of time F2 be longer than the period of time D as shown in the time chart for the tank internal pressure of FIG. 5 (such that the determination in Step S106 is “No”), the process may proceed to Step S121, so that Step S121 and its subsequent steps described above may be preformed.

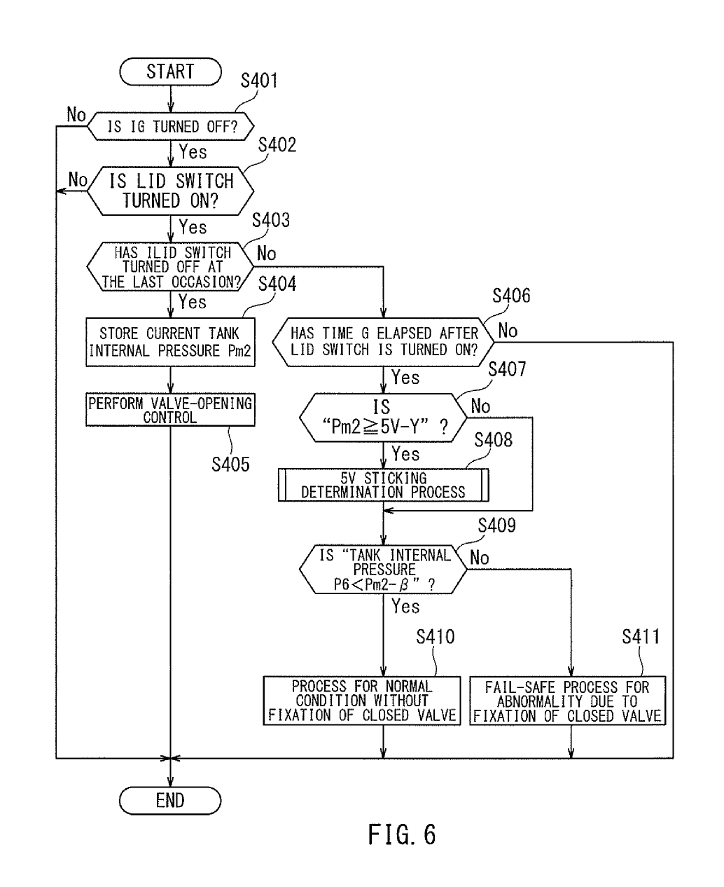

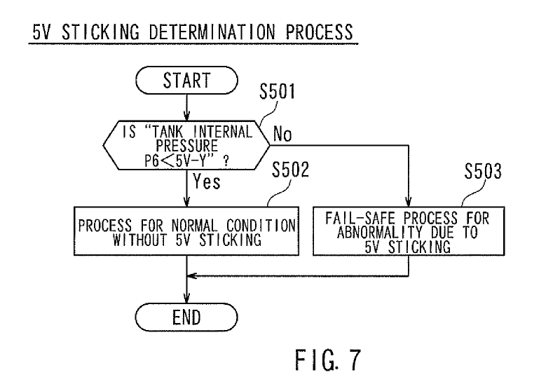

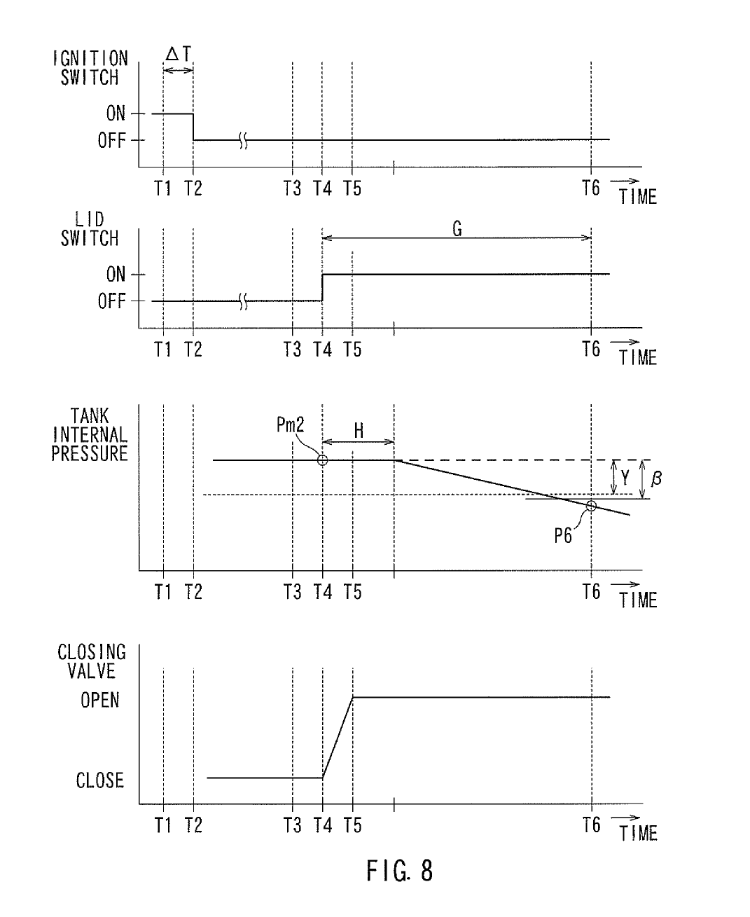

A process for determining abnormality of the tank internal pressure sensor 15p, and a process for determining abnormality of the closing valve 40 according to a second mode will now be described with reference to the flowcharts shown in FIGS. 6 and 7 and the time charts shown in FIG. 8. The processes shown in the flowcharts of FIGS. 6 and 7 may be cyclically or periodically performed with a period of a predetermined time (ΔT) according to a control program stored in the memory of the ECU 19. FIG. 8 illustrates the relationship between the operations for turning on and off the ignition switch (IG), the operations for turning on and off the lid switch 15s, a change in the tank internal pressure, and the operations for opening and closing the closing valve 40 during the process for determining the abnormality of the tank internal pressure 15p, and during the process for determining the abnormality of the closing valve 40, with time indicated by the horizontal axis. As will be described later, the processes according to the second mode may use the value “5 V−Y” as a reference for comparison with the detected pressure value for determining the abnormality due to sticking of the tank internal pressure sensor 15p. Therefore, the process for determining the abnormality of the tank internal pressure 15p according to the second mode will be also referred to as a “5 V sticking determination process.”

At time T2 of FIG. 8, the ignition switch is switched from on to off, so that the determination at Step S401 in FIG. 6 may be “Yes.” Then, the process may proceed to Step S402 that determines whether or not the lid switch 15s is turned on. In the time charts shown in FIG. 8, the lid switch 15s is turned off at time T2 (such that the determination in Step S402 is “No”), so that the process may be completed. The process Steps S401 and S402 of FIG. 6 may be repeatedly performed until the lid switch 15s is turned on at time T4 of FIG. 8 (such that the determination in Step S402 is “Yes”). Then, the process may proceed to Step S403 that determines whether or not the lid switch 15s has been turned off at the last occasion (i.e., during performing the process at the last cyclic period). In the time charts shown in FIG. 8, the lid switch 15s is turned off at the last occasion (at time T3) (such that the determination in Step S403 is “Yes”), so that the tank internal pressure Pm2 (0 V to 5 V) may be stored at Step S404. Subsequently, the closing valve 40 in the closed state may be opened at Step S405, and the process may then be completed. By opening the closing valve 40 to open the vapor passage 24, the pressure within the fuel tank 15 may be released, and the tank internal pressure may decrease gradually.

Next, at time T5 in the time charts shown in FIG. 8, the determination at Steps S401 and S402 in FIG. 6 may be “Yes”. At time T5, the lid switch 15s has been turned on at the last occasion (at time T4). Therefore, the determination in Step S403 may be “No.” The process may then proceed to Step S406 that determines whether or not a period of time G has elapsed after time T4, at which the lid switch 15s was turned on. Here, the period of time G may be set to be sufficiently larger than a period of time H during which the tank internal pressure may decrease through opening of the closing valve 40 but the inner pressure sensor 15p may not be possible to detect such a reduction, for example, due to delay in response. At time T5, the period of time G has not elapsed after time T4 at which the lid switch 15s was turned on (such that the determination in Step S406 is “No”). The process may be then completed.

In this way, with passage of time, Steps S401, S402, S403, and S406 in FIG. 6 may be repeatedly performed until the period of time G elapses at Time T6 in FIG. 8 (such that the determination in Step S406 is “Yes”) after the lid switch 15s has been turned on. Then, the process may proceed to Step S407 that determines whether or not the tank internal pressure Pm2 stored at Time T4 is equal to or larger than “5 V−Y” (i.e., Pm2≧5 V−Y). In one embodiment, Y may be set to approximately 0.3 V. Should the tank internal pressure Pm2 be smaller than “5 V−Y” (such that the determination in Step S407 is “No”), it may be considered that the tank internal pressure sensor 15p is not in an abnormal state (5 V sticking state) but in a normal state. Then the process may proceed to Step S409 without performing a 5 V sticking determination process that will be described later. Should the tank internal pressure Pm2 be larger than “5 V−Y” (such that the determination in Step S407 is “Yes”), the 5 V sticking determination process may be performed at Step S408.

The 5 V sticking determination process may be performed according to the flowchart shown in FIG. 7. First, Step S501 may compare the tank internal pressure P6 (0 V to 5 V) detected at time T6 with “5 V−Y.” Should the tank internal pressure P6 be smaller than “5 V−Y” as shown in the time chart of FIG. 8 (i.e., P6<5 V−Y) (such that the determination in Step S501 is “Yes”), it may be considered that the tank internal pressure sensor 15p is not in an abnormal state (5 V sticking state) but in the normal state. Then, the process may proceed to Step S502 in which a process for a normal condition without 5 V sticking may be performed. For example, this process may output a signal indicating that no abnormality has occurred. After that, the process may proceed to Sep 502 and further to Step S409 in FIG. 6. Should the tank internal pressure P6 be equal to or larger than “5 V−Y” (such that the determination in step S501 of FIG. 7 is “No”), it may be considered that the tank internal pressure P6 has not sufficiently decreased even at a time when the period of time G has elapsed after the opening of the closing valve 40. Therefore, there is a possibility that the tank internal pressure sensor 15p is in an abnormal state (5 V sticking state). Then, the process may proceed to Step S503 in which a fail-safe process for abnormality due to the 5 V sticking may be performed. For example, the fail-safe process may output a signal indicating that an abnormality has occurred. Thereafter, the process may proceed to Step S409 in FIG. 6. As described previously, the value of “5 V” of the tank internal pressure sensor 15p (tank internal pressure) may be a maximum detection value, and the value of “5 V−Y” may be a predetermined value that is smaller than and near the maximum detection value.

Step S409 of FIG. 6 may compare the tank internal pressure P6 at time T6 with the tank internal pressure Pm2 previously stored at time T4 when the lid switch 15s was turned on. Should the tank internal pressure P6 be smaller than “Pm2−β” at time T6 as shown in the time chart of FIG. 8 (i.e., P6<Pm2−β) (such that the determination in Step S409 is “Yes”), it may considered that the tank internal pressure has been reduced by a value of β or more after the closing valve 40 in the closed state is opened at time T4 (when lid switch 15s is turned on). This may mean that the closing valve 40 has properly (normally) operated for opening and has not been fixed in the closed state (i.e., fully closed position). Therefore, the process may proceed to Step S410 in which a process for a normal condition without fixation of the closing valve 40 at the closed position is performed. For example, this process may output a signal indicating that no abnormality has occurred. Should the tank internal pressure P6 be larger than “Pm2−β” (such that the determination in Step S409 is “No”), this may mean that the tank internal pressure P6 has not been reduced sufficiently even though the period of Time G has elapsed. Therefore, there is a possibility that the closing valve 40 has been fixed in the closed position. Then, the process may proceed to Step S411, in which a fail-safe process for abnormality due to the fixation of the closing valve 40 at the closing position is performed. For example, the fail-safe process may output a signal indicating that an abnormality has occurred. Based on this signal, an appropriate process may be performed to prevent the tank internal pressure from being excessively increased. In one embodiment, based on this signal, the ECU 19 may control the closing valve 40 to be opened when the tank internal pressure has increased to exceed a predetermined value, so that the tank internal pressure may be released to the canister 22.

As described above, the ECU 19 (more specifically, the microcomputer) performing the processes shown in the flowcharts of FIGS. 2 through 4 and FIGS. 6 and 7 serves as a determination device for determining the abnormality due to 0 V sticking of the tank internal pressure sensor 15p, the abnormality due to 5 V sticking of the tank internal pressure sensor 15p, the abnormality due to fixation in the opened position of the closing valve 40, and the abnormality due to fixation in the closed position of the closing valve 40.

With the fuel vapor processing apparatus 20 of this embodiment, the ECU 19 (abnormality determination device) may output control signals to the closing valve 40 for closing the closing valve 40 from the open state and for opening the closing valve 40 from the closed state, so that the pressure in the fuel tank 15 (tank internal pressure) may be changed. This change in the tank internal pressure may be used for determining the abnormality of the tank internal pressure sensor 15p (pressure detection device) based on the detection value (0 V to 5 V) of the tank internal pressure sensor 15p detected after closing the closing valve 40 or after opening the closing valve 40. Thus, it is possible to determine the abnormality of the tank internal pressure sensor 15p without changing a target for detection by the tank internal pressure sensor 15p. Therefore, a complicated determination device may not be necessary. Further, the ECU 19 (determination device) may determine the abnormality of the tank internal pressure sensor 15p while the engine 14 is inactive. Therefore, even in the case that, for example, the fuel vapor stored in the canister 22 has become excessive due to opening of the closing valve 40, the air fuel ratio of the engine 14 may not be affected.

Further, in the above embodiment, the ECU 19 (abnormality determination device) may output a control signal to close the closing valve 40 from the open state at the same time that the ignition switch is turned from on to off. Further, the ECU 19 may output a control signal to open the closing valve 40 from the closed state at the same time that the lid switch 15s is turned on according to the opening of the refueling port of the fuel tank 15. In this way, it may be possible to determine the abnormality of the tank internal pressure sensor 15p in association with the normally (ordinarily) performed control operations of the closing valve 40 during the purge operation. There is no need to specially operate the closing valve 40 for determination of the abnormality of the tank internal pressure sensor 15p. Further, in the case that the lid switch 15s is turned on and the closing valve 40 is opened from the closed state before the predetermined period of time D has elapsed after turning off the ignition switch, should the detection value of the tank internal pressure sensor 15p during closing of the closing valve 40 be smaller than the predetermined value (“0 V+X”) that is larger than and near the minimum detection value, the ECU 19 (abnormality determination device) may suspend the determination of the abnormality of the tank internal pressure sensor 15p. As a result, it may be possible to avoid such an occasion that the tank internal pressure sensor 15p is wrongly determined to be abnormal when the pressure in the fuel tank 15 (the detection value of the tank internal pressure sensor 15p) has not increased to the predetermined value (“0 V+X”) due to shortage of time.

Further, the determination of the abnormality of the closing valve 40 due to fixation in the open position and the determination of the abnormality of the tank internal pressure sensor 15p may be simultaneously or sequentially performed when the closing valve 40 is closed from the open state at the time of turning off the ignition switch. Therefore, the determination operations can be efficiently performed.

The above embodiment may be modified in various ways. For example, in the above embodiment, the closing valve 40 is opened from the closed state when the refueling port 15h is opened (when the lid switch 15s is turned on) for determining the abnormality of the tank internal pressure sensor 15p and for determining the abnormality of the closing valve 40 due to fixation in the closed position. However, it is also possible to determine these abnormalities when the pressure within the fuel tank 15 is released while the engine is at rest or inactive, i.e., when the closing valve 40 is opened from the closed state. Further, it may be also possible to determine the normality of the tank internal pressure sensor 15p and the abnormality of the closing valve 40 due to fixation in the open position when the closing valve 40 is closed from the open state after releasing the pressure within the fuel tank 15. Furthermore, in the above embodiment, the ECU 19 serves as a controller for outputting a control signal to the closing valve 15 for opening and closing the closing valve 16 and also serves as an abnormality determination device for determining abnormalities of the tank internal pressure sensor 15p and the closing valve 40. However, a separate controller form the ECU 19 may be provided for serving as the abnormality determination device. Furthermore, although the sticking of the tank internal pressure sensor 15p was described as an example of the abnormality of the pressure the tank internal pressure sensor 15p, the above teaching may be also applied to any other occasions that may cause fixation of a movable member, such as a diaphragm, for moving in response to the pressure.

Representative, non-limiting examples were described above in detail with reference to the attached drawings. The detailed description is intended to teach a person of skill in the art details for practicing aspects of the present teachings and thus is not intended to limit the scope of the invention. Furthermore, each of the additional features and teachings disclosed above may be applied and/or utilized separately or in conjunction with other features and teachings to provide improved fuel vapor processing apparatus, and methods of making and using the same.

Moreover, the various combinations of features and steps disclosed in the above detailed description may not be necessary to practice the invention in the broadest sense, and are instead taught to describe representative examples. Further, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed as informational, instructive and/or representative and may thus be construed separately and independently from each other. In addition, all value ranges and/or indications of groups of entities are also intended to include possible intermediate values and/or intermediate entities for the purpose of original written disclosure, as well as for the purpose of restricting the claimed subject matter.

What is claimed is:

1. A fuel vapor processing apparatus for an engine system including an engine and a fuel tank that stores fuel to be supplied to the engine, the fuel vapor processing apparatus comprising:
a canister configured to adsorb fuel vapor;
a vapor passage connecting the canister and the fuel tank, so that fuel vapor produced in the fuel tank is supplied to the canister via the vapor passage;
a purge passage connecting the canister and the engine, so that fuel vapor desorbed from the canister is purged to the engine via the purge passage;
a closing valve disposed in the vapor passage and configured to open and close the vapor passage;
a pressure detection device coupled to the fuel tank and configured to detect a pressure within the fuel tank; and
a controller coupled to the closing valve and the pressure detection device, the controller being configured to output a control signal to the closing valve for opening the closing valve from a closed position or for closing the closing valve from an open position, wherein:
the controller comprises a first abnormality determination device configured to determine whether or not the pressure detection device properly operates based on at least one of:
a detection value detected by the pressure detection device at a time when the engine is inactivated and after the controller outputs the control signal to the closing valve for opening the closing valve or for closing the closing valve; and
a detection value detected by the pressure detection device at a time when the engine is inactivated and after the controller outputs the control signal to the closing valve for closing the closing valve or for closing the closing valve.

2. The fuel vapor processing apparatus according to claim 1, wherein:
the engine system further includes an ignition switch coupled to the engine, so that the engine is activated and deactivated according to turning on and off the ignition switch, respectively; and
the controller is further coupled to the ignition switch and configured to output the control signal for closing the closing valve when the ignition switch is turned from on to off.

3. The fuel vapor processing apparatus according to claim 1, wherein:
the first abnormality determination device is configured to determine that the pressure detection device is operating properly if a detection value detected after the controller outputs the control signal to the closing valve for closing the closing valve is equal to or larger than a first predetermined value.

4. The fuel vapor processing apparatus according to claim 1, wherein:
the engine system further includes a lid configured to open and close a refueling port of the fuel tank; and
the controller is further configured to output the control signal to the closing valve to open the closing valve from the closed position when the lid is open.

5. The fuel vapor processing apparatus according to claim 4, wherein:
the first abnormality determination device is further configured to suspend determination of an abnormality if a detection value detected at the time or before the controller outputs the control signal to the closing valve for opening the closing valve from the closed position and before a predetermined time elapses after turning off the ignition switch is smaller than a predetermined value.

6. The fuel vapor processing apparatus according to claim 4, wherein:
the first abnormality determination device is further configured to determine that the closing valve is operating properly if a detection value detected after the controller outputs the control signal to the closing valve for opening the closing valve is smaller than a predetermined value.

7. The fuel vapor processing apparatus according to claim 2, wherein:
the controller further comprises a second abnormality detection device configured to determine whether the closing valve is in an abnormal condition or a normal condition, the abnormal condition being a condition in which the closing valve is accidentally fixed in an open position,
wherein the second abnormality detection device is configured to determine that the closing valve is in the normal condition if a detection value detected after the controller outputs the control signal to the closing valve for closing the closing valve is larger by a predetermined value than a detection value detected by the pressure detection device at a time when the ignition switch is turned from on to off.

8. The fuel vapor processing apparatus according to claim 4, wherein:
the controller further comprises a second abnormality detection device configured to determine whether the closing valve is in an abnormal condition or a normal condition, the abnormal condition being a condition in which the closing valve is accidentally fixed in a closed position, wherein:
the second abnormality detection device is configured to determine that the closing valve is in the normal condition if a detection value detected after the controller outputs the control signal to the closing valve for opening the closing valve is smaller by a predetermined value than a detection value detected at a time when the lid is opened from a closed position.

9. A fuel vapor processing apparatus for an engine system including an engine and a fuel tank that stores fuel to be supplied to the engine, the fuel vapor processing apparatus comprising:
a canister configured to adsorb fuel vapor;
a vapor passage connecting the canister and the fuel tank, so that fuel vapor produced in the fuel tank is supplied to the canister via the vapor passage;
a purge passage connecting the canister and the engine, so that fuel vapor desorbed from the canister is purged to the engine via the purge passage;
a valve disposed in the vapor passage and configured to open and close the vapor passage;
a pressure detection device coupled to the fuel tank and configured to detect a pressure within the fuel tank; and
a controller coupled to the valve and the pressure detection device, the controller being configured to output a control signal to the valve for opening or closing the valve; and
a determination device configured to determine whether or not the pressure detection device is operating properly to detect the pressure within the fuel tank based on a detection value of the pressure within the fuel tank detected by the pressure detection device at a time after the controller outputs the control signal to the valve to open or close the valve.

10. A fuel vapor processing apparatus for use with an engine system including an engine and a fuel tank that stores fuel to be supplied to the engine, the fuel vapor processing apparatus comprising:
a canister configured to adsorb fuel vapor produced in the fuel tank;
a purge passage connecting the canister and the engine, so that fuel vapor desorbed from the canister is purged to the engine via the purge passage;
a vapor passage connecting the canister and the fuel tank;
a valve disposed in the vapor passage and configured to open and close the vapor passage;
a pressure detection device coupled to the fuel tank and configured to detect a pressure within the fuel tank; and
a controller coupled to the valve and the pressure detection device, the controller being configured to output a control signal to the valve for opening or closing the valve; and
a determination device configured to determine whether or not the valve is operating properly in response to the control signal based on a difference between a first detection value and a second detection value of the pressure detection device; wherein:
the first detection value is detected at a time when or before the controller outputs the control signal to the valve to open or close the valve; and
the second detection value is detected at a predetermined time after the controller outputs the control signal to the valve to open or close the valve.
